(19) United States
(12) Patent Application Publication
(10) Pub. No.: US 2013/0015606 A1
(43) Pub. Date: Jan. 17, 2013

(54) PLASTICS INJECTION MOULDING TOOL AND METHOD FOR PLASTICS INJECTION MOULDING

(71) Applicant: Bernd Hackmann, Lohne (DE)

(72) Inventor: Bernd Hackmann, Lohne (DE)

(73) Assignee: RPC BRAMLAGE GMBH, Lohne (DE)

(21) Appl. No.: 13/575,104

(22) PCT Filed: Jan. 26, 2011
(86) PCT No.: PCT/EP11/51005

§ 371 Date: Sep. 25, 2012

(30) Foreign Application Priority Data
Jan. 26, 2010 (DE) 10 2010 000 196.1

(51) Int. Cl. B29C 45/28; B29C 45/27

(52) U.S. Cl. 264/328.15; 425/564

(57) ABSTRACT

The invention relates, in first instance, to a plastics injection moulding tool having a hot runner nozzle (1), the hot runner nozzle having an externally or internally heatable nozzle body and a nozzle tip (3), wherein a cooling action, associated with the nozzle tip, can be carried out. In order to provide a plastics injection moulding tool and a method for plastics injection moulding using a hot runner nozzle, in which effective cooling is possible at least at the end of the injection moulding cycle, it is proposed that a cooling device (10) is provided in a region of the nozzle body, directly at or near the nozzle tip. The invention further relates to a method for carrying out a plastics injection process using a hot runner nozzle.

The invention relates, in first instance, to a plastics injection moulding tool having a hot runner nozzle, the hot runner nozzle having an externally or internally heatable nozzle body and a nozzle tip, wherein a cooling action, associated with the nozzle tip, can also be carried out.

The invention further relates to a method for plastics injection moulding using a hot runner nozzle, the hot runner nozzle having an externally or internally heatable nozzle body with a nozzle tip, and a cooling action, associated with the nozzle tip, being carried out.

These types of plastics injection moulding tools and methods for plastics injection moulding are presently known in various embodiments. Reference is made, for example, to DE 19956215 C2, DE 29609356 U1, DE 202008006865 U1, and DE 102004033469 B3. With regard to cooling per se, reference is also made to DE 102005058963 A1 and DE 102008000452 A1. The measures for cooling described in the cited utility model and in the latter two cited publications, using a coolant which is initially liquid and then evaporated, are also included in full in the disclosure of the present application, including for the purpose of incorporating features of these above-referenced publications in claims of the present application.

With regard to hot runner nozzles, the known plastics injection moulding tools and methods for cooling are still not satisfactory. A more effective cooling option is sought.

On this basis, it is an object of the invention to provide a plastics injection moulding tool and a method for plastics injection moulding using a hot runner nozzle, in which effective cooling is possible at least at the end of the injection moulding cycle.

According to a first inventive concept, one possible solution for achieving the object is provided by the subject matter of claim 1, according to which a cooling device is provided in a region of the nozzle body directly in or near the nozzle tip. According to the invention, the cooling device is situated not externally, associated with the nozzle tip and optionally surrounding same, but, rather, in the nozzle tip itself. This allows effective cooling, specifically in the outermost region, in which the separation between the gate and the moulded part takes place during demoulding. In particular when the cooling device is a hot runner nozzle having a needle shut-off, the cooling device may also be provided in the needle itself.

With regard to the method, the invention further provides that at least in the course of, or beginning shortly before, the separation of the moulded body and the gate, the nozzle tip is cooled only briefly, if needed, by direct action on the nozzle tip.

Various options may be utilised for carrying out this cooling.

In first instance, the cooling is preferably carried out using a coolant which is conducted into the tip, a supply line and discharge line being provided for the coolant. These may be concentrically arranged tubes.

In the case of an internally heated hot runner nozzle, it may be provided for this purpose, for example, that a torpedo heater provided for this purpose, which as a rule is centrally situated in the hot runner nozzle, has an annular cross-section, for example, and leaves appropriate space for supply line paths in which the coolant, optionally with a certain insulation, may be supplied and discharged. In particular, it may also be provided that the necessary throttle point, or at least the exit of the coolant, which is preferably liquid, from the supply line, is provided directly in the nozzle tip. Within the scope of the present patent application, the nozzle tip refers in particular to the region of the hot runner nozzle which extends externally with a taper that results in the shut-off angle. This taper is generally cone-like. However, a front region of a shut-off needle, if one is provided, is also referred to as a nozzle tip, in particular the region which in the shut-off state projects beyond the nozzle tip and shuts off the gate opening to the workpiece. The aim in particular is that the mentioned conical tip itself, or the mentioned region of the shut-off needle, or the region surrounding the exit opening in the conical tip, such as for an externally heated hot runner nozzle, is cooled in such a way that practically no visible surface differences compared to the surrounding areas are detectable in the gate region of the separated workpiece.

The cooling may for example also be provided by electrical means. For example, one or more Peltier elements in this regard may be situated in the nozzle tip, or the nozzle tip itself may be formed as a Peltier element. In that case, the melt channel also optionally passes through the Peltier element. For this purpose, a suitable Peltier element may also have an annular shape, for example.

In terms of time, the cooling may be carried out in particular at the end of a plastics injection moulding cycle, beginning shortly before the demoulding until the actual separation of the mould halves, for example. Such intermittent cooling provides the cooling power, in particular when it is required for producing the desired high surface quality in the region of the gate.

The invention is explained further below with reference to the appended drawings, which, however, only represent exemplary embodiments. The figures show the following:

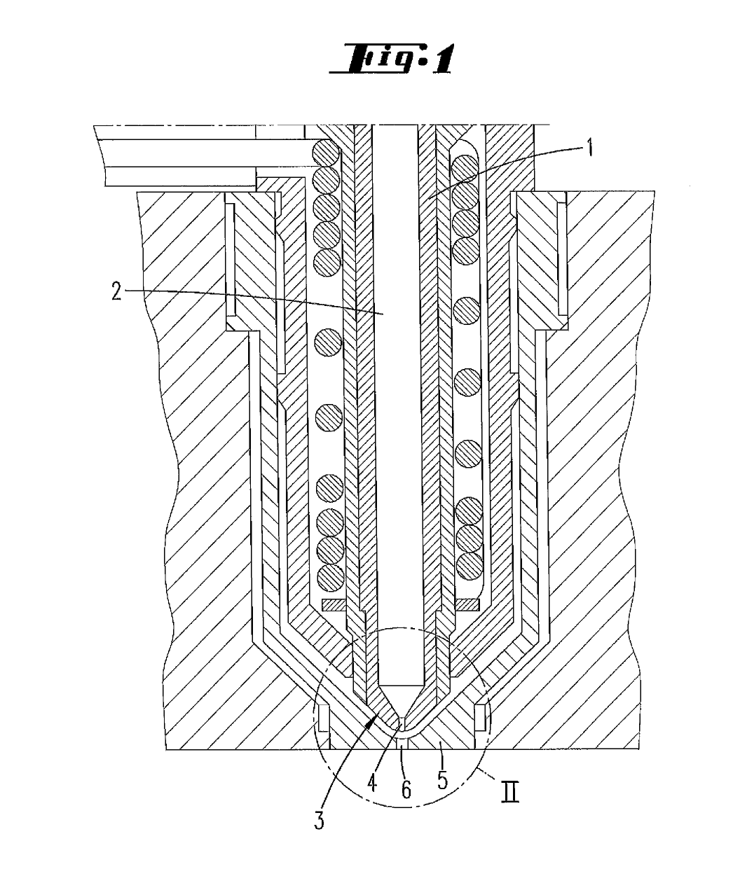

FIG. 1 shows a schematic cross-sectional illustration of a hot runner nozzle having external heating;

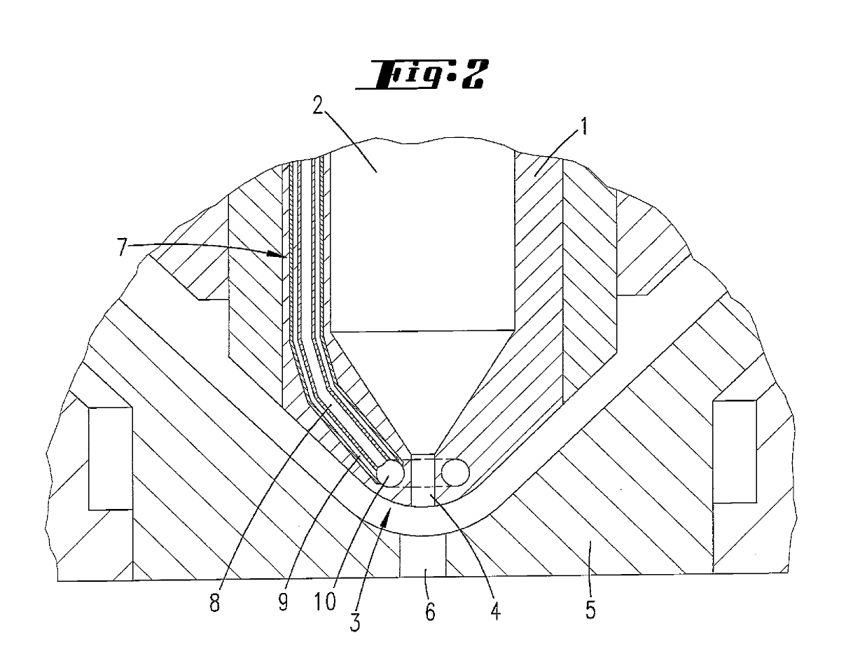

FIG. 2 shows an enlarged detail of the nozzle tip from FIG. 1;

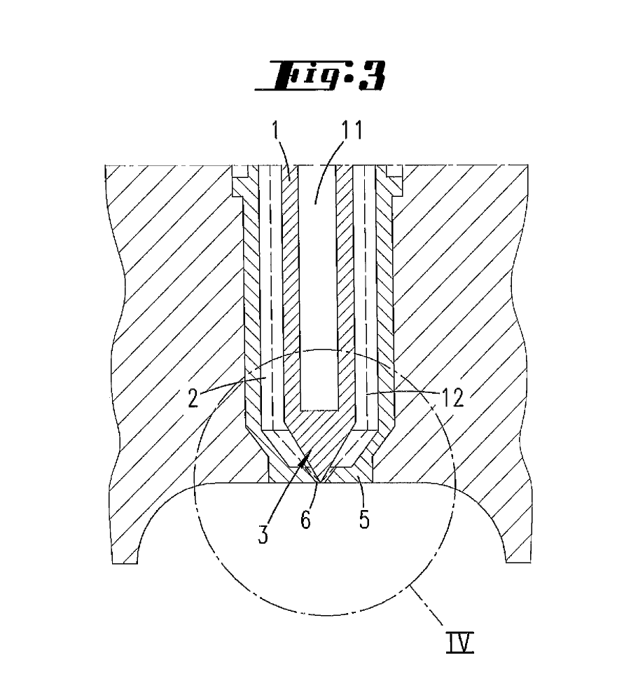

FIG. 3 shows a schematic cross-sectional view of a hot runner nozzle having internal heating;

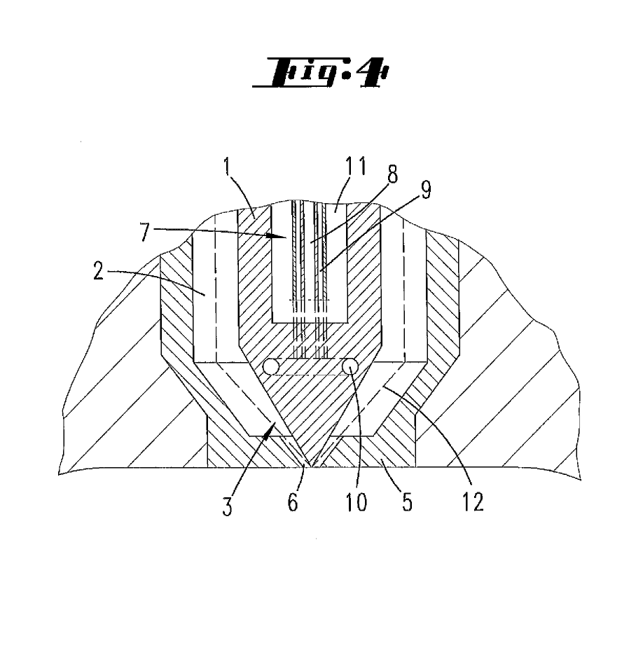

FIG. 4 shows an enlargement of the nozzle tip region in the illustration according to FIG. 3; and

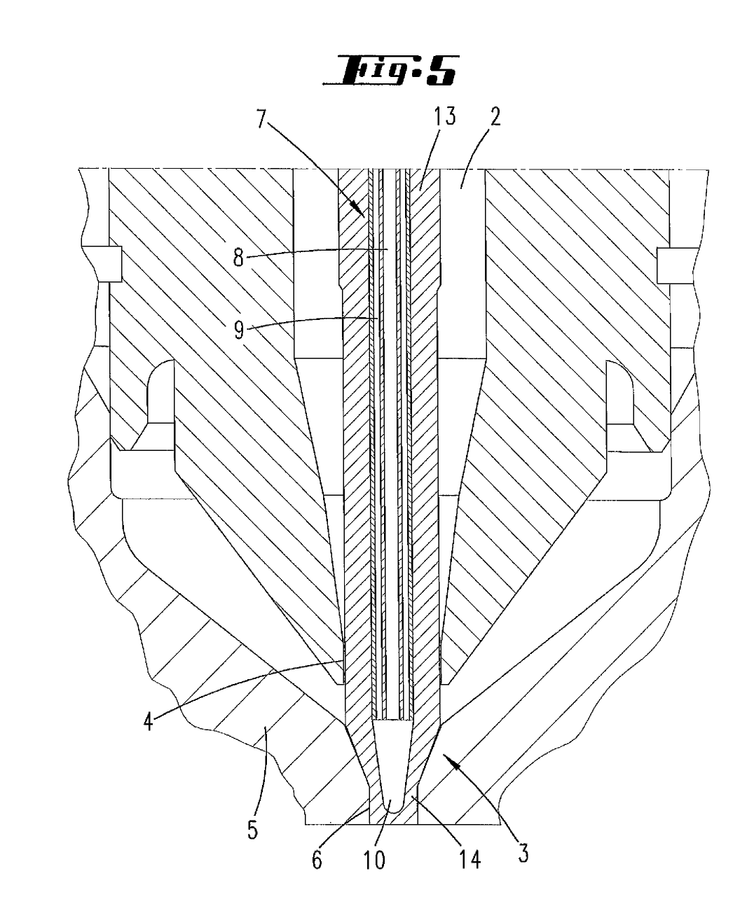

FIG. 5 shows a schematic cross-sectional illustration of a hot runner nozzle having a shut-off needle, in the shut-off state.

With reference initially to FIG. 1, a customary externally heated hot runner nozzle 1 is illustrated, which has a central melt conducting path 2 and a nozzle tip 3 having an exit channel 4 in the insert part 5 which forms the connecting path 6 to the tool cavity.

With reference to FIG. 2, it is apparent that, by means of a coaxially guided coolant line 7 which has an inner supply line 8 and an outer discharge line 9, liquid coolant is initially brought through the supply line 8 into the region of the nozzle tip 3, where it exits through a hole 10, resulting in an expansion effect, and thus, in a cooling action. In the present case, the hole 10 has an annular shape with respect to the exit path 4. However, the hole, additionally or alone, may also be provided at a region of the nozzle tip 3 further to the rear as viewed in the direction of the melt flow. The return line 9 may be provided coaxially as illustrated here, or it may be spatially offset with respect to the supply line 8.

In addition, cooling may also be provided in a region external to the nozzle tip, as described in principle in DE 202008006865 U1.

In a modification of the embodiment in FIG. 2, the region of the hole 10 may also be formed, for example, by an inset Peltier element, and appropriate electrical cable connections for acting on the Peltier element may be provided instead of the supply line and discharge line 8, 9, respectively. Use may also advantageously be made of the fact that the Peltier element emits heat on one side in the same way as it cools on the other side. In addition, the entire nozzle tip, for example, may be formed as a Peltier element.

A schematic cross-sectional view of an internally heated hot runner nozzle is illustrated with reference to FIG. 3. A torpedo heater 11 is situated inside the nozzle body 1. In the present case, the melt path 12 is arranged so that it surrounds the hot runner nozzle 1, and the melt is brought together in the region of the hot runner nozzle tip 3.

With reference to FIG. 4, it is schematically illustrated that the supply line and discharge line 8, 9, respectively, necessary for supplying and discharging the coolant may be implemented here by a heating cartridge 11 having an annular cross-section, and the associated hole 10 may then be provided in the nozzle tip. Here as well, the required expansion results from the exit of the liquid coolant from the supply line 9, which is kept very narrow.

Alternatively (not illustrated), here as well, the nozzle tip as a whole, or, by way of example here, the portion of the nozzle tip corresponding to the hole 10, may be formed as a Peltier element, in which case the electrical supply and discharge lines are also brought through the heating cartridge 11, for example, similarly as for lines 8 and 9.

A hot runner nozzle 1 is illustrated in cross-section with reference to FIG. 5, in which a shut-off needle 13 is centrally situated inside the hot runner nozzle. Also in this embodiment, the supply line and discharge line 8, 9, respectively, for a coolant are provided inside the shut-off needle 13, as well as a recess or cavity 10, so that an evaporating coolant allows appropriate cooling of the tip 14 of the shut-off needle 13.

The supply line and discharge line may in principle be kept very narrow. Their diameters may be in the millimeter, one-tenth of a millimeter, or even micron range. In addition, the lines do not have to be concentric, and may also be provided next to one another. The supply line may have a smaller diameter than the discharge line, for example. These lines may be provided in the parts by laser, for example.

With regard to the temperatures, it is preferred that cooling of the nozzle tip, specifically also the mentioned needle tip, is carried out up to a temperature, for example, of 50 degrees or less, and down to 0 degrees or a few degrees below zero, for example minus 5 degrees. All intermediate values, in particular in 0.5-degree increments, are hereby included in the disclosure, on the one hand for delimiting the mentioned range from the bottom and/or top, and on the other hand also for disclosure of individual values in the mentioned range. A part ejected from the mould usually has a wall temperature of 40 degrees or less. In any event, it is the aim that the injection-moulded part has approximately this temperature, also in the region of the gate.

All features disclosed are (in themselves) pertinent to the invention. The disclosure content of the associated/accompanying priority documents (copy of the prior application) is also hereby included in full in the disclosure of the application, including for the purpose of incorporating features of these documents in claims of the present application. The subsidiary claims in their optional subordinated formulation characterise independent inventive refinement of the prior art, in particular to undertake divisional applications based on these claims.

1. Plastics injection moulding tool having a hot runner nozzle, the hot runner nozzle having an externally or internally heatable nozzle body and a nozzle tip, and wherein a cooling action, associated with the nozzle tip, can be carried out, wherein a cooling device is provided in a region of the nozzle body directly at or near the nozzle tip.

2. Plastics injection moulding tool according to claim 1, wherein the cooling is carried out using a supply line and discharge line for a coolant.

3. Plastics injection moulding tool according to claim 1, wherein the coolant is conducted through a central region of a heating cartridge having an annular cross-section.

4. Plastics injection moulding tool according to claim 1, wherein the hot runner nozzle has a shut-off needle, and wherein the shut-off needle is coolable at least in its region which in the shut-off state projects beyond the nozzle body.

5. Method for carrying out a plastics injection moulding process using a hot runner nozzle, the hot runner nozzle having an externally or internally heatable nozzle body and a nozzle tip, and a cooling action, associated with the nozzle tip, being carried out, wherein the cooling is carried out in a region of the nozzle body itself, directly at or near the nozzle tip.

6. Method according to claim 5, wherein the hot runner nozzle has a shut-off needle, and wherein the shut-off needle itself is cooled.

7. Method according to claim 5, wherein the shut-off needle is cooled at least in its shut-off needle region which in the shut-off state projects beyond the nozzle body.

8. Method according to claim 5, wherein the cooling is carried out in a region of the nozzle body itself, directly at or near the nozzle tip, by supplying and discharging a coolant which expands preferably in the region of the nozzle tip.

9. Method according to claim 5, wherein the cooling is carried out only intermittently, preferably at a time associated with the end of the injection moulding cycle, shortly before demoulding of the injection-moulded part.
